(19) United States
(12) Patent Application Publication
(10) Pub. No.: US 2020/0363241 A1
(43) Pub. Date: Nov. 19, 2020

(54) COHERENT FIBER BRAGG GRATING SENSOR SYSTEMS AND METHODS

(71) Applicant: Fiber SenSys, LLC, Hillsboro, OR (US)

(72) Inventors: Duwayne Anderson, St. Helens, OR (US); Kendra Centracco, Portland, OR (US)

(21) Appl. No.: 15/930,051

(22) Filed: May 12, 2020

Related U.S. Application Data
(60) Provisional application No. 62/849,328, filed on May 17, 2019.

(51) Int. Cl. G01D 5/353

(52) U.S. Cl. CPC G01D 5/35316

(57) ABSTRACT

A sensor apparatus can include an optical fiber having regularly spaced fiber Bragg gratings (FBGs) and a light source configured to emit a pulse of light into the optical fiber. The sensor apparatus includes a coupler to receive reflections of the pulse of light from the FBGs and output the reflections to two outputs coupled to a second coupler, one of the outputs having a delay element. Reflected pulses from adjacent FBGs arrive at the second coupler temporally aligned and are combined in the second coupler. The second coupler has outputs that are out of phase with each other by a known quantity. A detector receives the combined pulses from two of the outputs of the second coupler and determines a rate of phase change. The detector can determine, from the rate of phase change, a location on the optical fiber that is distorted. Related aspects also are described.

### FIELD

This application and related subject matter (collectively referred to as the “disclosure”) generally concern interferometers, interferometry-based sensors, and related systems and methods. More particularly, but not exclusively, this disclosure pertains to sensors that detect strain in a fiber-optic cable having fiber Bragg gratings on an optical fiber.

### BACKGROUND INFORMATION

Interferometry is a method of measurement using the interference of waves, such as electromagnetic or sound waves. When two waveforms are superimposed on each other, or interfered, the waveforms combine to form a new waveform. When waveforms having the same wavelength and frequency are coherent, that is, generally in phase or aligned, the waveforms may constructively interfere, resulting in a waveform that has a peak amplitude of the two maxima added together. When the waveforms are out of phase, where the maxima of one waveform align with the minima of the other waveform, the waveforms may destructively interfere such that little or no light (or wave) is observed. In states of alignment that exist between in-phase and out-of-phase, the amplitude of the combined waveform will reflect the additive or subtractive effects of one waveform on the other.

A wave source, e.g., light, may be emitted along two different paths, reflected at the ends of the respective paths, and then combined. When the two different paths remain, respectively, unchanged in length, the combined waveform will remain constant. In the case where the two different paths have the same length and when the waveforms on the two paths are aligned, the combined waveform may have twice the amplitude of the separate waveforms. When the difference in the length the two paths changes with respect to each other, the combined waveform will change, because one of the waveforms will have traveled a different distance with respect to the other, and will generally, no longer align in the way in which it was aligned before. The change in the combined waveform may therefore indicate that the length of at least one of the paths has changed.

Interferometry can be used to show that a path length has changed, but does not usually indicate where the change has occurred on the changed path length.

### SUMMARY

Interferometer sensor systems disclosed herein detect strain along an optical fiber having fiber Bragg gratings. The strain may be due to, for example, the presence of an intruder or a leak in an adjacent pipeline. More particularly, the disclosed systems and methods can locate a specific segment between two fiber Bragg gratings on the optical fiber where the strain is occurring.

Concepts, systems, methods, and apparatus disclosed herein overcome many problems in the prior art and address one or more needs as described below, or other needs. In some respects, concepts disclosed here generally concern an apparatus having a fiber optic cable comprising an optical fiber having a plurality of regions with a gradient in refractive index distributed longitudinally throughout or along a segment of the optical fiber. The distribution may be periodic or aperiodic. The apparatus can have a light source configured to emit a pulse of coherent light into the optical fiber. The apparatus can have a first coupler optically coupled to the fiber optic cable and so configured to receive a corresponding pulse of light reflected from each respective region and to split each respective received pulse into a corresponding upper output and a corresponding lower output. The apparatus can have a first optical path optically coupled to the upper output and comprising a delay element, and a second optical path optically coupled to the lower output and having a length shorter than the first optical path. The apparatus can have a second coupler having a first input coupled to the first optical path, and a second input coupled to the second optical path, and configured to receive and combine a first received pulse from the first optical path with a second received pulse from the second optical path into a combined pulse, and to output the combined pulse to each of a first output and a second output, wherein the first output and the second output are out of phase with each other. The apparatus can have a detection component configured to receive the combined pulse from the respective first output and from the respective second output, and to detect a distortion event at a location between a pair of adjacent regions based on a phase difference between the first received pulse and the second received pulse of the combined pulse.

The detection component can have a first optical receiver coupled to the first output and configured to convert the received combined pulse to a first electronic signal; a second optical receiver coupled to the second output and configured to convert the received combined pulse to a second electronic signal; and a processing component configured to receive the first and second electronic signals, to measure a phase difference between the first received pulse and the second received pulse based on the first and second electronic signals, and to detect the distortion event at a location between a pair of adjacent regions based on the measured phase difference.

The first output of the second coupler and the second output of the second coupler can be out of phase with each other by about 120 degrees.

The detected distortion event can be a change in temperature at the location.

The detection component can be configured to measure a change in temperature between a pair of adjacent regions. The detection component can be configured to measure fringe visibility based on the received combined pulse, and to determine the change in temperature based on the fringe visibility.

Each respective region in the optical fiber can be spaced apart from an adjacent region by a first distance, and the delay element can have a length that is about an integral multiple of the first distance. The delay length can be twice the first distance.

The apparatus can include a circulator configured to direct a light pulse from the light source to the optical fiber, and a reflected pulse of light from the optical fiber to the first coupler.

The apparatus can include a phase modulator coupled to the second optical path configured to normalize the signal.

The apparatus can include a polarization controller configured to receive a series of pulses of light from the light source and to vary the polarization of the pulses of light.

The first received pulse can correspond to a pulse reflected from a first region and the second received pulse corresponds to a pulse reflected from a region serially adjacent to the first region.

The detection component can include a third optical path coupled to the first output of the second coupler and having a second delay element; a fourth optical path coupled to the second output of the second coupler; a third coupler having a right input coupled to the third optical path and a left input coupled to the fourth optical path, the third coupler configured to multiplex the optical signals received at the right and left inputs in the time-domain and output the multiplexed signal; an optical receiver coupled to the third coupler and configured to receive and convert the time-domain multiplexed signal convert the received recombined pulse to an electronic signal; and a processing component configured to receive the first and second electronic signals, to measure the phase difference between the first received pulse and the second received pulse based on the first and second electronic signals, and to detect the distortion event at a location between a pair of adjacent regions based on the measured phase difference.

Each respective region can be spaced apart from an adjacent FBG by a first distance, and the second delay element can have a length less than the first distance. The second delay element can have a length that is one half of the first distance.

The detected distortion event can include a presence of a target.

The detection component can emit an alert when a distortion event is detected.

The detection component can detect a distortion event in real-time.

The plurality of regions with a gradient in refractive index can include a plurality of fiber Bragg gratings.

In other respects, a sensor can include a first coupler having an optical coupling configured to receive a series of pulses of light and so configured to split each respective received pulse into a corresponding upper output and a corresponding lower output; a first optical path optically coupled to the upper output and comprising a delay element; and a second optical path coupled to the lower output having a length shorter than the first optical path. The sensor can have a second coupler having a first input coupled to the first optical path, and a second input coupled to the second optical path, configured to receive and combine a first received pulse from the first optical path with a second received pulse from the second optical path into a combined pulse, and to output the combined pulse to each of a first output and a second output, wherein the first output and the second output are out of phase with each other. The sensor can have a third optical path coupled to the first output of the second coupler and having a second delay element; a fourth optical path coupled to the second output of the second coupler; and a multiplexer having a right input coupled to the third optical path and a left input coupled to the fourth optical path, the multiplexer configured to multiplex the optical signals received at the right and left inputs in the time-domain and output the multiplexed signal.

The optical coupling can be configured to connect to a fiber optic cable.

The multiplexer can include a third coupler having a right input coupled to the third optical path and a left input coupled to the fourth optical path, the third coupler configured to multiplex the optical signals received at the right and left inputs in the time-domain and output the multiplexed signal; and an optical receiver coupled to the third coupler and configured to receive and convert the time-domain multiplexed signal convert the received recombined pulse to an electronic signal.

The sensor can include a phase modulator coupled to the second optical path configured to normalize the signal.

The sensor can include a fiber optic cable, connected to the coupling, comprising an optical fiber having a plurality of fiber Bragg gratings (FBG) spaced apart from each other; and a light source configured to emit a pulse of coherent light into the optical fiber.

Each respective FBG in the sensor can be spaced apart from an adjacent FBG by a first distance, and the delay element can have a length that is about an integral multiple of the first distance. The second delay element can have a length that is a less than the first distance. The second delay element length can be one half of the first distance.

The sensor can include a detection component configured to receive the multiplexed signal from the multiplexor, and to detect a distortion event at a location between a pair of adjacent FBGs based on a phase difference between the first received pulse and the second received pulse of the combined pulse.

In still other respects, a sensor can include a first coupler having an optical coupling configured to receive a series of pulses of light and so configured to split each respective received pulse into a corresponding upper output and a corresponding lower output; a first optical path optically coupled to the upper output and comprising a delay element; and a second optical path coupled to the lower output having a length shorter than the first optical path. The sensor can include a second coupler having a first input coupled to the first optical path, and a second input coupled to the second optical path, and configured to receive and combine a first received pulse from the first optical path with a second received pulse from the second optical path into a combined pulse, and to output the combined pulse to each of a first output and a second output, wherein the first output and the second output are out of phase with each other. The sensor can include a detection component configured to receive the combined pulse from the respective first output and from the respective second output, and to detect a distortion event based on a phase difference between the first received pulse and the second received pulse of the combined pulse.

The optical coupling can be configured to connect to a fiber optic cable comprising an optical fiber having a plurality of fiber Bragg gratings (FBGs) spaced apart from one another.

The detection component can include a first optical receiver coupled to the first output and configured to convert the received combined pulse to a first electronic signal; a second optical receiver coupled to the second output and configured to convert the received combined pulse to a second electronic signal; and a processing component configured to receive the first and second electronic signals, to measure a phase difference between the first received pulse and the second received pulse based on the first and second electronic signals, and to detect the distortion event at a location between a pair of adjacent FBGs based on the measured phase difference.

Each respective FBG can be spaced apart from an adjacent FBG by a first distance, and the delay element can have a length that is about an integral multiple of the first distance. The delay element length can be about twice the first distance.

The first received pulse can correspond to a pulse reflected from a first FBG and the second received pulse can correspond to a pulse reflected from an FBG serially adjacent to the first FBG.

The first output of the second coupler and the second output of the second coupler can be out of phase with each other by about 120 degrees.

The detected distortion event can include a change in temperature at the location, or a presence of a target.

In still other respects, a system can include a fiber optic cable comprising an optical fiber having plurality of fiber Bragg gratings (FBG) spaced apart from each other; a light source configured to emit a pulse of coherent light into the optical fiber; and an interferometric sensor apparatus configured to receive a corresponding pulse of light reflected from each respective FBG, identify a segment of the optical fiber between a pair of adjacent FBGs experiencing strain, the identifying based on the received pulses of reflected light, and output an alert responsive to identifying the segment experiencing strain.

In still other respects, an apparatus can include a processor; a communication component configured to receive a signal; and a computer-readable medium comprising instructions, that, when executed by the processor, cause the apparatus to: receive, via the communication component, a first signal representing a combination of reflected light from a pair of adjacent reflectors, and a second signal representing the combination of reflected light, wherein the second signal is at a known phase difference from the first signal. The instructions can cause the apparatus of measure a phase difference between the first received signal and the second received signal based on the first and second electronic signals; determine a rate of change in the measured phase difference; compare the rate of change to a threshold; detect a distortion event when the rate of change exceeds the threshold; and emit an alert when a distortion event is detected.

Also disclosed are associated methods, as well as tangible, non-transitory computer-readable media including computer executable instructions that, when executed, cause a computing environment to implement one or more methods disclosed herein. Digital signal processors embodied in software, firmware, or hardware and being suitable for implementing such instructions also are disclosed.

The foregoing and other features and advantages will become more apparent from the following detailed description, which proceeds with reference to the accompanying drawings.

### BRIEF DESCRIPTION OF THE DRAWINGS

Referring to the drawings, wherein like numerals refer to like parts throughout the several views and this specification, aspects of presently disclosed principles are illustrated by way of example, and not by way of limitation.

FIG. 1 illustrates an example of a fiber optic cable-based Michelson interferometer.

FIG. 2 illustrates an example of a fiber optic cable-based time domain reflectometer.

FIG. 3 illustrates a graph showing a relationship between the total phase difference caused by a strain on a leg of a fiber optic cable-based Michelson interferometer and interferometric output.

FIG. 4 illustrates a model of a phase measured by an interferometer as a part of a rotating phasor.

FIG. 5 illustrates an example of a coherent fiber Bragg grating (FBG) fiber optic sensor system.

FIG. 6 illustrates an example of an effect of a delay element on an optical path of the FBG sensor system.

FIG. 7 illustrates the use of a 3×3 coupler in the FBG sensor system of FIG. 5.

FIG. 8 illustrates a phasor diagram of the signals received from two of the outputs from a 3×3 coupler in the FBG sensor system of FIG. 5.

FIG. 9 illustrates an example of the summed spectral energy from a spectrograph such as may be generated by a detection component in the FBG sensor system of FIG. 5.

FIG. 10 illustrates an example of a part of an FBG sensor system that uses time domain multiplexing to combine the outputs of a 3×3 coupler.

FIG. 11 illustrates a block diagram of an example of a detection component.

FIG. 12 illustrates aspects of measuring a change in temperature using the FBG sensor system of FIG. 5.

FIG. 13 illustrates a plot of the total phase shown in FIG. 12 superimposed with its related averaged slope shown in FIG. 12.

FIG. 14 illustrates an example of a relationship between optical path lengths and fringe visibility.

FIG. 15 illustrates a relationship between fringe visibility and temperature.

FIG. 16 illustrates a block diagram showing aspects of a computing environment.

### DETAILED DESCRIPTION

The following describes various principles related to interferometer-based sensor devices, and related systems and methods. For example, some disclosed principles pertain to systems, methods, and components to detect a location of an intruder and/or a change in temperature along a length of fiber optical cable. As but one illustrative example, a system may include an interferometer having a plurality of optical paths within one fiber optic cable having fiber Bragg gratings (FBGs) serially disposed within an optical fiber in the cable. Each FBG may reflect at least some of the light that arrives at the FBG, thus each respective FBG defines a halfway point for a corresponding round-trip optical path in the optical fiber within the fiber optic cable. The interferometer may delay some of the reflected pulses so that pulses reflected from adjacent FBGs can be combined, which is analogous to pulses reflected from mirrors in a conventional Michelson interferometer arriving together at a detector. The system may further include a detection component that may measure a phase difference in the light reflected from the pair of adjacent FBGs to identify a distortion event occurring between the pair of adjacent FBGs. That said, descriptions herein of specific appliance, apparatus or system configurations, and specific combinations of method acts, are but particular examples of contemplated sensors, components, systems, and methods chosen as being convenient illustrative examples of disclosed principles. One or more of the disclosed principles can be incorporated in various other sensors, components, systems, and methods to achieve any of a variety of corresponding, desired characteristics. Thus, a person of ordinary skill in the art, following a review of this disclosure, will appreciate that sensors, components, systems, and methods having attributes that are different from those specific examples discussed herein can embody one or more presently disclosed principles, and can be used in applications not described herein in detail. Such alternative embodiments also fall within the scope of this disclosure.

### I. Overview

For some purposes, it may be sufficient, in interferometry, to know that a path length has changed, without needing to know the location on the path where the length change occurred.

However, for other purposes, for example, in security and environmental monitoring applications, a location of a security breach or an environmental condition may be important so that the breach or condition may be addressed. Conventional interferometers are not able to provide such location information.

Generally, for example, in a Michelson interferometer, a beam or pulse of light, such as from a laser, is shone into one optical path, and then split into two separate optical paths, for example, with a beam splitter such as, but not limited to, a partially reflective, partially transmissive piece of glass. The two beams or pulses are reflected back along their same respective optical paths toward the point where they were split and recombine into a single beam.

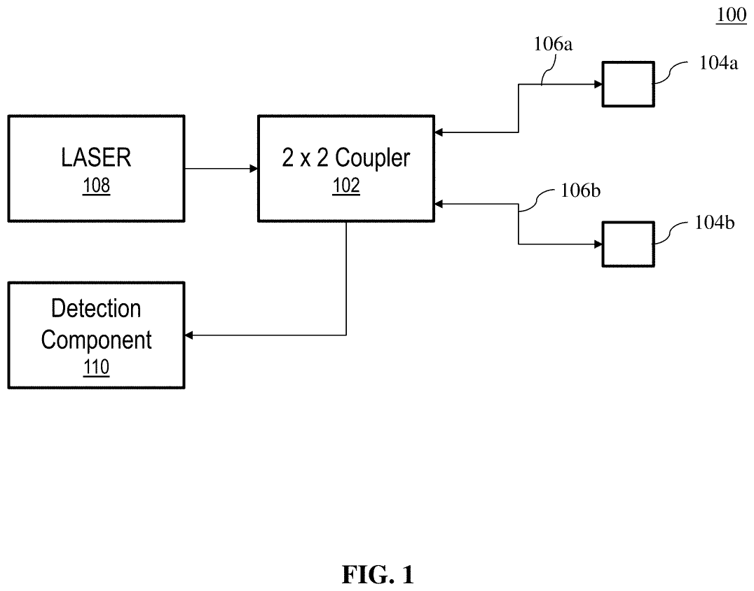

FIG. 1 illustrates an example of a fiber-optic-cable-based Michelson interferometer 100. As used herein, a fiber optic cable refers to a cable having at least one optical fiber capable of “carrying” light along its length. That is, the light travels substantially along and through the length of the optical fiber with little to no transmission of the light outside of the optical fiber cable. Optical fibers are generally made of plastic or glass that may be coated and/or cladded to produce total internal reflection of the light within the fiber, preventing the light from “leaking” from the fiber. Additional layers may be applied surrounding the optical fiber(s) in the fiber optic cable, for example, to protect the optical fiber(s) from abrasions, environmental contamination or damage, animal damage, or damage from human activity.

The interferometer 100 may have a source of coherent light, e.g., laser 108. As used herein, “coherent light” means that all the light waves from the source have the same frequency and phase. The laser 108 may produce monochromatic light, that is, light at a single wavelength. As used herein, the term “light” refers to radiation in any selected band of the electromagnetic spectrum, for example, radio frequency waves, visible light waves, ultraviolet waves, or X-rays.

Light from the laser 108 may enter a 2×2 coupler 102, which may act as a beam-splitter. The light may emerge from the coupler 102 along two separate optical paths 106a and 106b. As used herein, an optical path means the direction and distance that light travels, and the medium through which it travels. An optical path is generally linear unless the medium includes means of guiding the light through a non-linear path. An optical path may be through air or other gas, or through a liquid or a vacuum in a vessel such as a pipe, tube, or chamber. The optical paths 106a and 106b may be provided by fiber optic cable containing at least one optical fiber. The optical paths may end at mirrors 104a and 104b, respectively, which may reflect the light to return to the coupler 102. The reflected light from the two optical paths may be recombined in the coupler 102 and output to a detection component 110.

The recombined beam may be observed, either, for example, by shining it onto a screen, or via a detector. The waves of the two beams, when recombined, will interfere with each other and may be observed as a power fluctuation, commonly called interference fringes. Fringe visibility (FV), a measure of how much interference is observed, is a function of the degree of coherence. It can be calculated by the equation: FV=(Max−Min)/(Max+Min), where Max represents the maximum power and Min represents the minimum power. When Min→Max the fringe visibility approaches zero and when Min→0 and Max gets large the fringe visibility approaches 1. It is possible to measure and map the fringe visibility envelop along the length of the laser pulse using a Michelson interferometer with one adjustable leg shown.

A Michelson interferometer may be designed so that, absent any distortion events, the light beams or pulses will constructively interfere when recombined. As long as the lengths of the two optical paths remain unchanged, the recombined beams may combine such that a light is observed, or a maximum power is observed. When one of the optical paths is distorted with respect to the other, the distortion may cause a change in optical path length, which will appear as a change in the observed interference pattern, e.g., the fringe pattern changes.

The detection component 110 may receive the recombined light and may emit some indication of the interference in the recombined light. The indication may be, for example, an analog or digital signal indicative of the fringe pattern. The detection component 110 may include additional components, such as an optical receiver, a charge coupled device (CCD) camera, an analog to digital converter, or other detector and processing components to measure the power of the received optical signal and output a representation of the signal. If one of the path lengths of the optical paths 106a or 106b changes relative to the other path length, the detection component 110 may output a representation of the changes to the optical signal as a result of the change in path length.

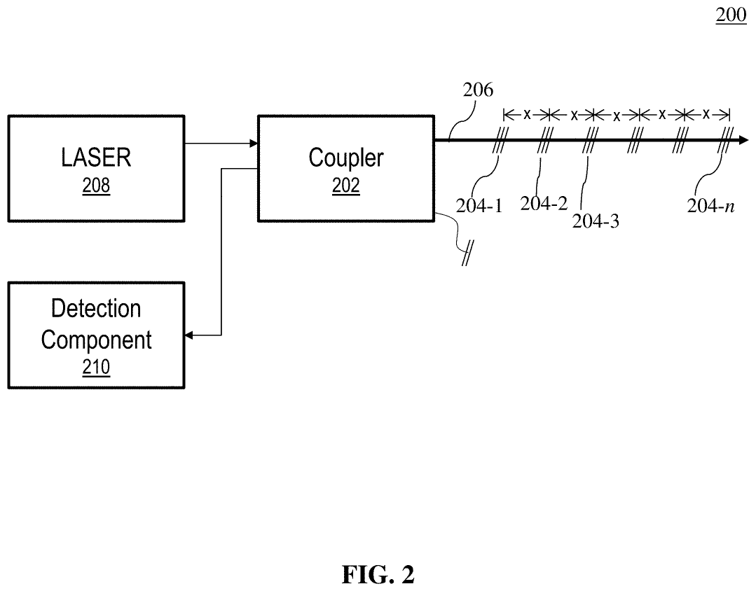

FIG. 2 illustrates an example of a time domain reflectometer 200. The time domain reflectometer 200 uses a fiber optic cable that has internal fiber Bragg gratings (FBGs) in an optical fiber, e.g., FBG 204-1 to FBG 204-n. In an embodiment, the optical fiber in the fiber optic cable is a single-mode fiber, which may be configured to carry a single mode of light. Single-mode fiber may carry light for longer distance relative to multi-mode fiber, with less dispersion.

A fiber Bragg grating is inscribed into an optical fiber in a fiber optic cable to change the refractive index at the grating, and acts as a partial reflector for a specific wavelength or narrow range of wavelengths of light. A plurality of spaced FBGs in an optical fiber can create a corresponding plurality of optical paths for light traveling within the optical fiber. In an embodiment, the FBGs are equally or substantially equally spaced apart along a length of the optical fiber. For example, one optical path on optical fiber 206 may include the path from the coupler 202 to FBG 204-1 and back to the coupler 202. Another optical path may include the path from the coupler 202 to FBG 204-3 and back to the coupler 202.

The laser 208 may emit light having one or more wavelengths, although only light of the wavelengths specific to the FBGs will be reflected back.

Conventionally, the detection component 210 may include a polarization sensor. When a distortion of the optical fiber occurs, for example, when pressure is applied to a segment between two adjacent FBGs or when the temperature of a segment changes, the detection component 210 may detect a change in the polarization of the light due to the distortion of the optical fiber. However, while the sensor is able to determine where a first distortion occurs, it will not be able to determine the locations of any additional distortions, because the additional distortions are coupled to the first distortion.

Interferometric output for a Michelson interferometer, including the interferometer 100 may be described by equation 1.1:

$$I = \frac{{I}_{0}}{2} ( 1 + cos ( Δϕ + {ϕ}_{0} ) ) \qquad [ 1.1 ]$$

In equation 1.1, Δφ is the optical phase difference between the two legs or paths of the interferometer, and is defined by:

$$Δϕ = \frac{Δ O P L}{λ} \cdot 2 \cdot π \qquad [ 1.2 ]$$

where ΔOPL is the difference in optical path length and λ is the vacuum wavelength of the laser. Applying a positive strain to only one of the two optical paths, e.g., to optical path 106a but not 106b, or to the optical path comprising the path between the coupler 202 and the FBG 204-3 but not to the optical path between the coupler 202 and the FBG 204-2, increases the difference between the two optical path lengths: represented as ΔOPL. As strain to the one optical path increases, the phase difference, represented by equation 1.2, increases in approximately a linear fashion. Applying the same strain to both paths, however, will not cause an observable change.

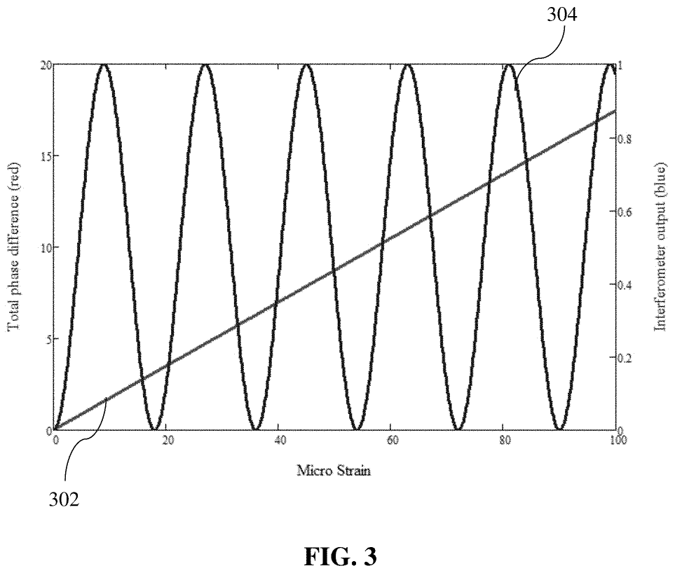

Substituting equation 1.2 into equation 1.1 results in a relationship, shown in FIG. 3, between the total phase difference caused by the strain, represented by line 302, and interferometric output, represented by line 304. As the strain to the one optical path increases, the total phase difference increases.

Interferometers are able to provide highly precise measurements of small changes in strain because of the short wavelength of light. For example, suppose the length of the optical fibers 106a and 106b of the interferometer 100 are 1 meter long. If one optical fiber is subjected to strain, and the other is sequestered, then a microstrain (10⁻⁶) on the strained optical fiber will result in a change of the optical path length (OPL) of approximately 3 microns, given by the calculation 2(10⁻⁶×1 m×1.456), assuming an index of refraction of 1.456 for the optical fiber. The expression in parentheses is doubled due to the round trip of the light in the fiber section. If the interferometer has a wavelength of 1.5 microns, this change in OPL will result in a phase change of about 6π, corresponding to roughly 5 full cycles between zero and maximum output on the interferometer. Assuming the interferometer has reasonably low noise, it should be able to resolve down to a milliradian of phase change, which would (in this example) equal a resolution of about 0.15 nanostrain. Optical fibers with different indexes of refraction may provide different resolution. The embodiments are not limited by this example. Similarly, a strain to a portion of an FBG optical fiber, e.g., strain between a pair of adjacent FBGs, may result in a change of the OPL that includes the strained portion of the optical fiber, and may be detected with the same or similar resolution.

Despite the high sensitivity to small strain, the interferometric output is only proportional to the cosine of Δφ, the optical phase difference between the two legs of the interferometer. A more useful measure would be the optical phase difference itself. There are several reasons for wanting to know Δφ instead of cos(Δφ). For example, the function cos(Δφ) has zero points (at the extrema) where a differential change in Δφ results in a vanishingly small change in the output signal. At the extrema, the sensor sensitivity fades for small signals, presenting a serious problem for security sensors that must function optimally at all times.

Another reason for wanting to know Δφ instead of cos(Δφ) is that the cos(Δφ) function makes it difficult to classify a type of vibration causing a distortion that may be detected by the interferometer. In security applications, being able to classify a vibration may be important to be able to distinguish genuine intrusions from environmental effects. A small but high-frequency variation in Δφ can have a similar signature to a large but lower-frequency variation. This can make it very difficult to use standard frequency notch filters to distinguish between, for example, a low-intensity transformer vibrating at 60 Hz and a high-intensity 20-Hz engine running nearby. That's because the 20-Hz engine may produce a signal large enough to cause frequency tripling, putting the engine's 20-Hz signal into the 60-Hz notch-filter range.

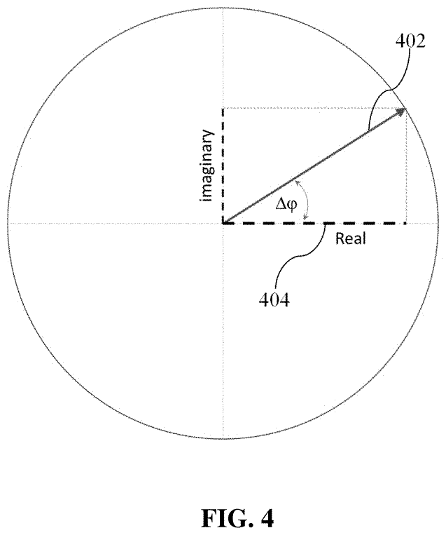

As shown, for example, in FIG. 4, the phase in equation 1.1 can be modeled as the angle of a rotating phasor 402, with the real part 404 of the phasor being proportional to the output of the interferometer, e.g., to the optical power of the signal. A phasor is a vector that represents a sinusoidally varying quantity by means of a line rotating about a point in a plane, the magnitude of the quantity being proportional to the length of the line and the phase of the quantity being equal to the angle between the line and a reference line. Direct measurement of the output of, for example, the interferometer 100 or reflectometer 200, gives only the real part of the phasor, which leaves the phasor indeterminate, since it could be in either one of two different quadrants. This ambiguity prevents knowledge of the absolute state of the phasor, and thus the absolute phase.

Accordingly, the sinusoidal output of the interferometer 100 or reflectometer 200 may prevent making direct measurements of optical phase changes due to distortion events, except when the signal of interest is very small and doesn't change the optical phase by more than a few degrees. To be truly useful, a sensor system and method of determining the input, Δφ, from the interferometric output, over an arbitrarily large range of input values is needed.

### II. Sensor System for Detecting a Distortion Event

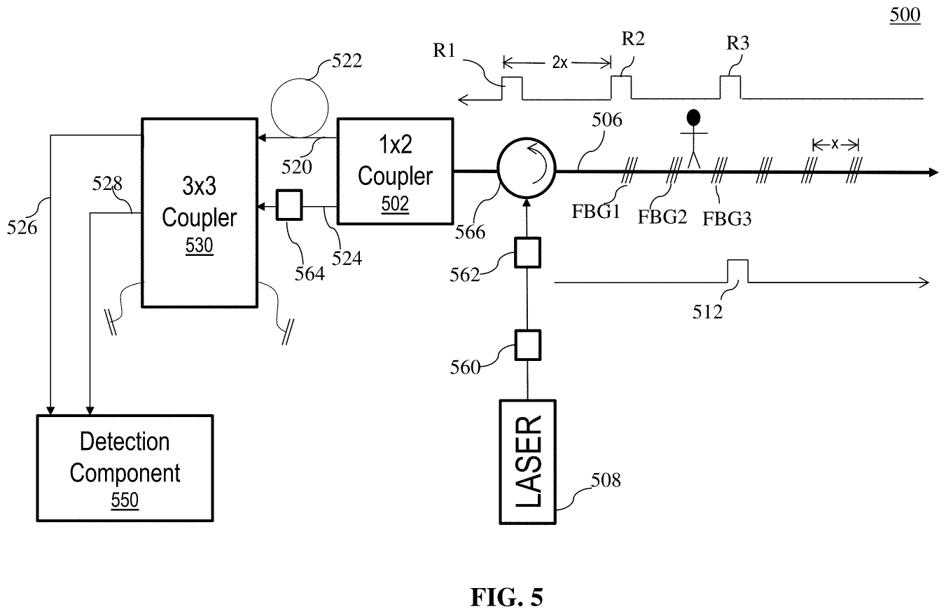

FIG. 5 illustrates an example of a coherent FBG fiber optic sensor system 500 that overcomes the shortcomings described above. The system 500 may measure the actual optical phase change created by distortion events and may identify a location of a distortion event along an optical fiber. A distortion event may refer to any condition that causes a strain, e.g., a change to an optical path length in an optical fiber. Examples of distortion events include, without limitation, changes in temperature in an area around a segment of optical fiber, pressure applied to a segment of optical fiber, and vibrations at a segment of optical fiber.

Some distortion events may be of interest, for example, for security monitoring, and/or for safety or environmental monitoring. The fiber optic cable containing an optical fiber with FBGs (“FBG cable”) may be installed on a site, for example, underground along or near a security perimeter or a pipeline, or above ground along a fence or a wall. The FBG cable may be installed on or in walls or floors of a building. Changes in temperature may occur due to, for example, a gas, liquid, or mixture thereof, leaking from a pipe or storage tank into the environment near an FBG cable of the system 500. A change in temperature may occur due to occlusion of the sun or other heat source by a vehicle or object placed between the heat source and the FBG cable. Pressure on the FBG cable may be due to the weight of an intruder or vehicle on the FBG cable, either stationary or in motion; or due to activities such as digging with a shovel near or above the FBG cable, or striking a surface with a hammer near the FBG cable. Vibrations at the FBG cable may be due to, for example, the motion of a person climbing a fence near the FBG, a vehicle motor or generator operating near the FBG cable, or construction equipment operating near the FBG. Other sources of pressure, vibration, and temperature change may be detected according to a particular application of the embodiments.

The system 500 may include a light source, e.g., laser 508, that is configured to emit a pulse 512 of coherent light into an optical fiber 506. Different types and configurations of lasers may be used. The laser used for a given installation may be selected according to an optical power and spectral width (or coherence length) needed. In one example, a 20 mW power laser emitting light with a wavelength of 1550 nm and a spectral bandwidth of less than 0.1 nm may be used. Other considerations for selecting a laser may include one or more of a drive current, capacitance, operating temperature range, and inclusion of an internal optical isolator.

The optical fiber 506 may be a single mode fiber having a plurality of regions with a gradient in diffractive index distributed longitudinally throughout a segment of the fiber. The regions with a gradient in diffractive index may be fiber Bragg gratings (FBGs), e.g., FBG1, FBG2, FBG3. The length of the fiber optic cable containing the optical fiber with FBGs may be between about 1 km to 10 km, e.g., 0.9 km, 1.5 km, 5 km, 8 km, or 10.5 km. The length of the fiber optic cable may be limited by the optical loss that occurs at each FBG, such that, beyond a certain length, the amount of light reflected by FBG at that length is insufficient to be detected by a receiver.

The FBGs may be spaced apart from each other by a distance x. The distance x between FBGs may be between about 10 m to about 100 m, for example, 9.5 m, 10 m, 20 m, 40 m, 75 m, or 101 m. The pulse 512 may comprise light continuously emitted by the laser over a period of about 10 nanoseconds (ns), e.g., 8 ns, 9 ns, 11 ns, or 15 ns. In an embodiment, the laser may emit separate pulses at a rate that allows a given pulse to reach the last FBG and for its reflection to be received at the coupler 502 before the subsequent pulse is emitted. For example, if a light pulse takes 0.1 ms to travel round trip to the last FBG and back, then the laser may emit pulses at a rate slower than every 0.1 ms, e.g., 0.12 ms, 0.15 ms, 0.2 ms, or 0.3 ms.

In another embodiment, the pulses may be emitted at a rate that is shorter than the longest round-trip time if, for example, there is a way to distinguish between adjacent pulses. For example, two or more different lasers (not shown) may be used to emit pulses having different wavelengths such that any two sequential pulses differ from each other in wavelength. In another example, one laser may emit sequential pulses having different wavelengths such that any two sequential pulses differ from each other in wavelength. In still another example, one or more filters, dyes or other mechanisms may be applied to alternate or sequentially change the wavelength of the laser light after the pulse is emitted by the laser but before the pulse enters the optical fiber.

The pulse 512 may be reflected by each respective FBG. For example, reflected pulse R1 may represent the pulse 512 reflected from FBG1, reflected pulse R2 may be the reflection from FBG2, and reflected pulse R3 may be the reflection from FBG3. The reflected pulses may be separated by a second distance that is twice the separation of the FBGs, that is, by 2x. For example, when the pulse reaches FBG1 and is partly reflected there, the reflected pulse R1 is traveling back toward the coupler 502 while the pulse 512 is still traveling outward toward FBG2. In the time it takes the pulse to travel the distance “x” to reach FBG2, the reflected pulse R1 has also traveled the distance “x” back. The next reflected pulse R2, from FBG2, travels “x” back toward FBG1, and R1 has traveled “x” again, meaning that the separation of R1 and R2 is 2x.

In an embodiment, the pulse 512 emitted by the laser 508, and the reflected pulses may pass through a circulator 566. The circulator 566 may route light from the laser to the optical fiber 506, and light received from the optical fiber 506 to a coupler 502.

The coupler 502 may be a 1×2 coupler that is configured to receive light from the optical fiber 506, e.g., the reflected pulses. The coupler 502 may split each respective received pulse into two outputs, e.g., an upper output and a lower output. The use of designations of “upper” and “lower” are meant to distinguish between two outputs, rather than to limit the positioning of the outputs.

The upper output may be coupled to a first optical path 520, e.g., another optical fiber. The lower output may be coupled to a second optical path 524, e.g. still another optical fiber. One of the optical paths, e.g., optical path 520, may have a delay element 522 that causes a reflected pulse, e.g., R1, on the optical path 520 to arrive at the coupler 530 at a later time than the corresponding split R1 pulse on the optical path 524. The delay caused by the delay element 522 may result, for example, from additional length of an optical fiber included in the first optical path, compared to the length of the second optical path. The delay caused by the delay element 522 may result from other means to effectively lengthen the optical path, for example, an arrangement of reflectors. In an embodiment, the delay element 522 may be twice the length of the spacing of the FBGs, e.g., 2×. The delay element 522 may cause a pulse reflected from one FBG, e.g., FBG2, to arrive at the coupler at the same time as a pulse reflected from an adjacent FBG that is further from the coupler, e.g., FBG3, when no strain is present between the pair of adjacent FBGs. When a strain is present between a pair of adjacent FBGs, the pulse on the upper output and the corresponding pulse on the lower output may arrive at the coupler at different times, where the time difference is based on the difference in optical path length caused by the strain.

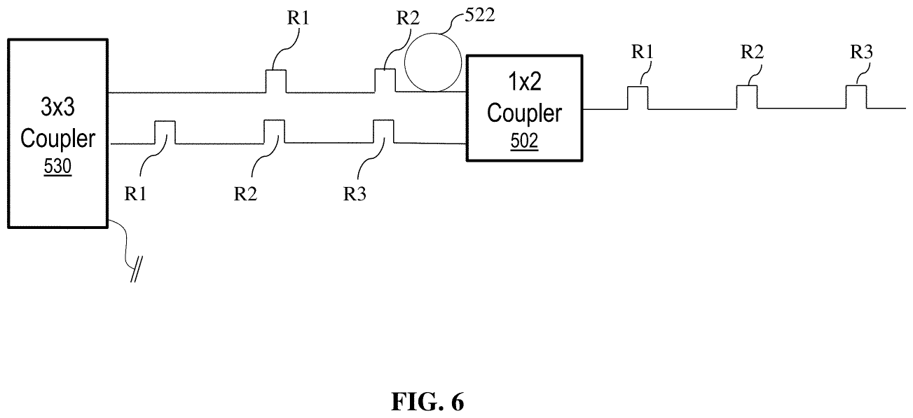

FIG. 6 illustrates an example of the effect of the delay element 522. When a reflected pulse R1 arrives at the coupler 502, it is split into respective upper and lower pulses at the upper and lower outputs. The upper and lower pulses are output simultaneously onto the first and second optical paths. On the upper optical path 520, the upper pulse R1 travels through the additional path length provided by the delay element 522, while the lower pulse R1 is not delayed. The lower pulse R1 accordingly arrives at the coupler 530 before the upper pulse R1. Similarly, the reflected pulse R2 is split into upper and lower pulses, where the upper pulse is similarly delayed relative to the lower pulse.

The upper pulse R1, due to the delay element, arrives at the coupler 530 substantially simultaneously with the lower pulse R2. Thus, pulses reflected from adjacent FBGs arrive together at the coupler 530, which is analogous to pulses reflected from the mirrors 104a and 104b arriving together at the coupler 102.

Returning now to FIG. 5, the coupler 530 is configured to receive the upper and lower pulses from the first and second optical paths. The coupler 530 may be a 3×3 coupler, having three inputs and three outputs. One of the inputs is not used, and one of the outputs is not used. A 3×3 coupler is used, rather than a 2×2 coupler, because signal phase difference between the output ports of a 3×3 coupler are nominally 1200 apart, where the outputs of a 2×2 coupler are not. This signal phase difference can be used to analyze the interferometric signal in quadrature and thus to determine the absolute phase difference in the reflected pulses as will be described. Other couplers may be used, provided that the optical phase delay between the outputs is neither 0° nor 180°.

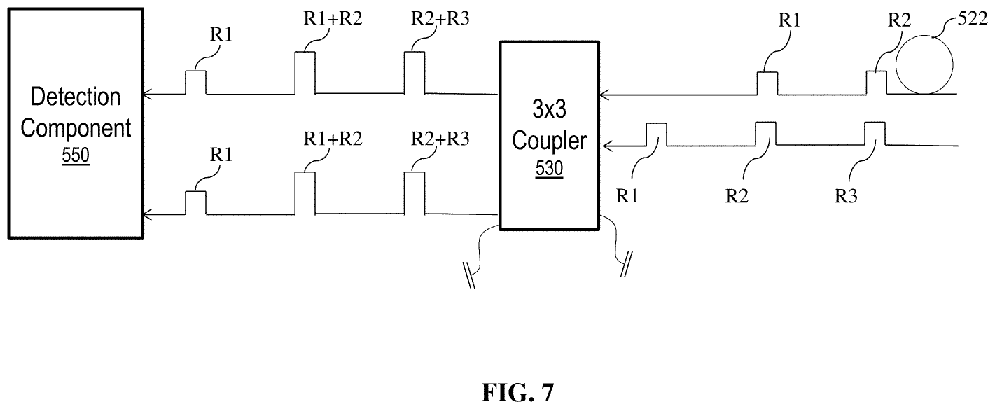

The coupler 530 is configured to combine a pair of the received corresponding upper and lower pulses interferometrically, resulting in a combined waveform. As shown in FIG. 7, pulses reflected from adjacent FBGs, e.g., R1 with R2, or R2 with R3, may be combined together in the coupler 530, and each combined pulse may be split and output from two of the three outputs. A constant phase difference between the outputs of the coupler 530 may be about 120°, ±30°.

This phase difference may be used to make quadrature measurements, which can determine the absolute phase difference in the reflected pulses, rather than the cosine of the phase difference, as will be explained below.

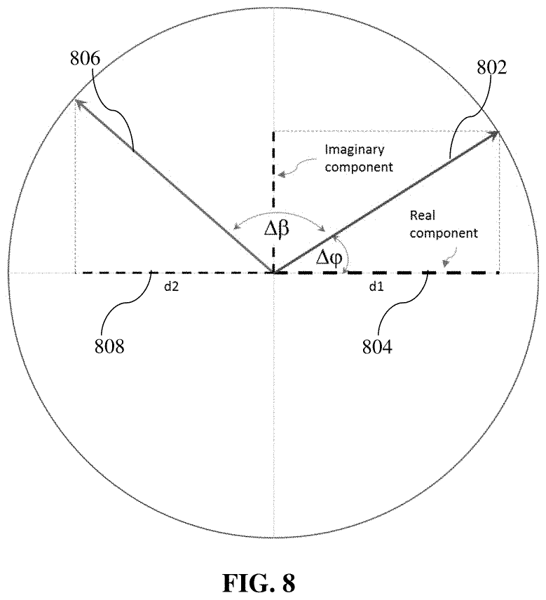

FIG. 8 illustrates a phasor diagram of the signals received from two of the outputs from the coupler 530, e.g., signals received on optical paths 526 and 528. In the figure, d1 (line 804) represents the power of the signal on optical path 526, and d2 (line 808) represents the power of the signal on optical path 528, while A is the constant phase difference between two adjacent output ports on the 3×3 coupler 530.

Solving the quadrature problem, i.e., determining which quadrant the phasor is in, may involve finding the imaginary component of either of the phasors 802 or 806 in FIG. 7. For example, the following two equations describe the phasors 802, 806.

d1=cos(Δϕ) [1.3]

d2=cos(Δϕ+Δβ) [1.4]

Adding equations 1.3 and 1.4, and expanding cos(Δϕ+Δβ), yields:

d1+d2=cos(Δϕ)+cos(Δϕ)·cos(Δβ)−sin(Δϕ)−sin(Δβ) [1.5]

Substituting d1 for cos(Δϕ), setting Im=sin(Δϕ), and collecting terms, produces:

$$Im = \frac{d 1 \cdot cos ( Δβ ) - d 2}{sin ( Δβ )} \qquad [ 1.6 ]$$

where Im is the imaginary part of the phasor 802, and d1 (line 804) is the real part. The full phasor may be expressed as a time-dependent 3-vector:

$$phasor ( t ) = ⌈ \frac{\begin{matrix}d 1 ( t ) \\ d 1 ( t ) \cdot cos ( Δβ ) - d 2 ( t )\end{matrix}}{\begin{matrix}sin ( Δβ ) \\ 0\end{matrix}} ⌉ \qquad [ 1.7 ]$$

The phasor is now presented as a function of time, and the change in the time-sampled phasor's phase can be calculated as shown:

δϕᵢ=a sin[[phasor (tᵢ)×phasor (tᵢ₋₁)]₂] [1.8]

Equation 1.8 is for a system in which the phasor is measured at discrete times, and assumes that the phasor moves less than 180 degrees between those sample points. If this assumption is met, the time-dependent absolute phase can be determined by integrating or summing, regardless of how many times the phasor moves through 2·π, using equation 1.9, which represents raw time-domain data:

ϕ(tᵢ)=Σₖ₌₀ⁱδϕₖ [1.9]

Returning again to FIG. 5, the detection component 550 may be coupled to the optical paths 526 and 528, and may receive the outputs of the coupler 530 via the optical paths. The detection component 550 may, accordingly, receive a signal on each of two different inputs. Each of the respective signals received at the two inputs at a given time corresponds to the combined signal from a pair of adjacent FBGs. One of the two received signals at the given time is optically out of phase with respect to the other of the two received signals by about 120°±30°. For example, at a given time, each of the two inputs may receive an optical signal corresponding to the combination of R1+R2, however, the signal received at one input is optically out of phase with the signal received at the other input.

The detection component 550 may count, track, assign an order to, or otherwise determine which received signals are associated with respective FBGs. For example, returning to FIG. 7, the first reflected pulse from the first FBG, e.g., R1 shown on the lower input to the coupler 530, may arrive at the coupler 530 without a corresponding pulse on the upper input. This reflected pulse may be ignored or discarded, while indicating the beginning of a train of reflected pulses from an outgoing laser pulse. The reflected pulses arriving subsequently may be grouped and numbered (or otherwise identified). For example, the pulses R1 and R2 that arrive together at the coupler 530 correspond to the first segment or zone between the first and second FBGs, the pulses R2 and R3 that arrive together correspond to the second segment or zone between the second and third FBGs, and so on. The pulse (Rₙ) reflected from the last FBGₙ on the optical fiber will also arrive unpaired at the coupler 530 on the upper input after the pair of (Rₙ₋₁ and Rₙ) arrives, which signifies that the reflections from a particular pulse have ended. The first and last unpaired reflected pulses may generally have a lower power or amplitude compared to the combined reflected pulses, because they have not been interfered with another pulse. In some embodiments, the system 500 may include a clock or other synchronizing signal that informs the detection component 550 when each laser pulse is emitted and from which the detection component 550 may calculate or otherwise determine when the reflections from a particular pulse begin arriving.

Consequently, when a distortion event is detected, as will be discussed below, the pulse associated with the detected event identifies which segment of the optical fiber experienced the strain caused by the event. For example, if the 11^{th} combined pulse is associated with the detected distortion event, the event is located between the 11^{th} and 12^{th} FBG.

The detection component 550 may use the pair of signals with equation 1.9 above to generate a phasor signal corresponding to a section of fiber between the FBGs associated with the signal. The detection component 550 may execute intrusion software or processor instructions to determine whether the phasor signal indicates a distortion event, such as may be created by the presence of an intruder near the corresponding section of fiber or a change in temperature near the corresponding section of fiber.

For example, the intrusion software may measure the optical power of the fringes in the signal for a given segment. Because the fringe pattern changes when one path of an interferometer changes relative to the other, such a change may indicate a distortion caused by a an dintruder or a temperature change. In another example, the intrusion software may, for example, apply a fast Fourier transform, or other transformation between time and frequency domains, to the angle of the phasor to create a spectrograph to which digital processing techniques may be applied to infer the presence of a signal of interest (e.g., an intruder or a liquid leak).

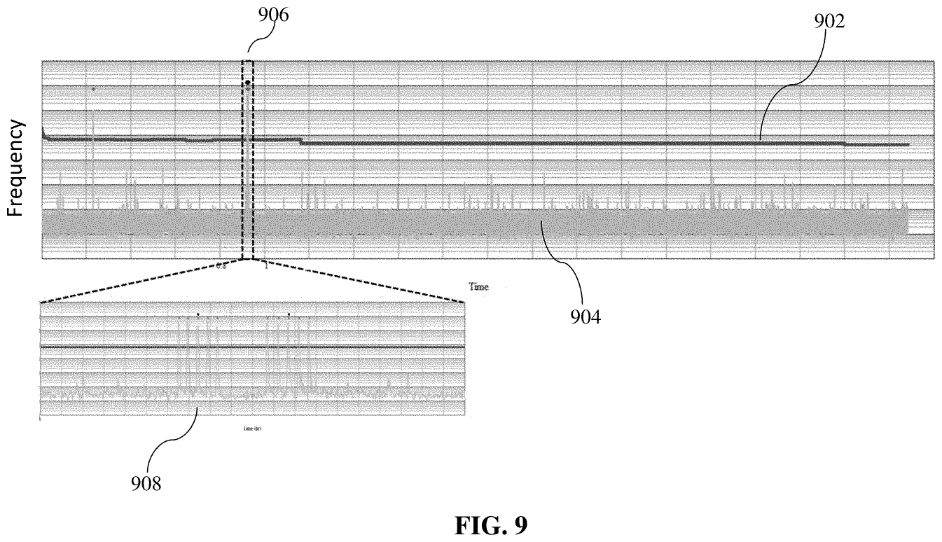

FIG. 9 illustrates an example of the summed spectral energy from a spectrograph such as may be generated by intrusion software of a detection component. For example, the change in the time-sampled phasor in the time-domain may be transformed to the frequency domain. The transformed frequency-domain data may be summed in each sample set, between a lower limit frequency and an upper limit frequency, to generate summed spectral energy. The summed spectral energy 904 may represent how quickly the phasor angle changes over time, as provided, for example, from the raw time-domain data of equation 1.9. A distortion event is indicated by the spike 906 in the spectrograph. The summed spectral energy of the distortion event is above a threshold 902. The threshold 902 may be selected manually by an operator, during a tuning process for a given installation, or automatically by a computing device executing an algorithm trained to detect statistically significant changes to the phasor angle relative to a normal level.

Expanding the time resolution on the x-axis shows, in plot 908, that the spike 906 may be caused by a series of individual spikes in spectral energy, for example, such as may be caused by repeated blows to an area within a sensing region of a section of optical fiber.

Returning to FIG. 5, in some embodiments, the system 500 may include a semiconductor optical amplifier 560 for use with a laser 508 that is a low-power modulated laser. The semiconductor optical amplifier 560 may amplify the light from the low-power modulated laser while maintaining the low-power light's longer coherence length. The coherence length refers to a distance over which the coherent light remains coherent. In the disclosed systems, a longer coherence length is desirable so that the light stays coherent over the length of the optical fiber. The semiconductor optical amplifier may enable a relatively inexpensive process for producing pulses in the normally continuous light source of the laser. This relatively inexpensive process includes switching the power to the laser on and off repeatedly to produce pulses of light. However, pulsing a laser in this way may change the coherence of the emitted light, shortening the coherence length. The semiconductor optical amplifier 560 preserves the low-power light's longer coherence length.

The system 500 may include a polarization controller 562 configured to receive a series of pulses of light from the light source and to vary the polarization of the pulses of light over a period, e.g., a complete revolution of polarization direction about every 20 seconds, e.g., every 18 seconds, 22 seconds, or 25 seconds. The polarization of the light emitted from the laser may drift through the optical fiber. If the optical fiber is located near a high voltage line, for example, the polarization may further be affected through the Kerr effect. The use of the polarization controller 562 may reduce the amount of time that the light is polarized in a direction that limits or eliminates its detectability.

The system 500 may include a phase modulator 564 coupled to the second optical path 524. The phase modulator 564 may be used to calibrate or normalize the signal output from the coupler 502, for example, to a few Hz. Normalizing the signal may increase a signal to noise ratio of the phase difference.

The sensor systems described herein are improved relative to conventional fiber Bragg sensor systems in that improvements allow the identification of a location of a distortion event. This location identification is possible because the sensitivity of the optical fiber between FBG pairs (or zones) is all independent of the other zones. For example, if an intruder stimulates the fiber between FBGs 2 and 3, an intrusion signal will be detected on that zone, but no intrusion signal will be seen on any other zones (pairs of FBGs). Alarms may only be generated for a particular zone when the fiber in that zone (between the two FBGs that define the zone) is disturbed, and for no others. This is a direct consequence of the fact that phase variations in the fiber before FBGx (the xth FBG in the array) are common to the reflections from both FBGx and FBGx+1 (the two FBGs that form a given pair) and are not part of the interferometric signal, as seen in equation 1.10.

$${phasor}_{zone x} = {e}^{\sqrt{- 1} ( {φ}_{{FBG}_{x}} )} + {e}^{\sqrt{- 1} ( {φ}_{{FBG}_{x + 1}} )} = {e}^{\sqrt{- 1} ( {φ}_{{FBG}_{x}} )} \cdot ( 1 + {e}^{\sqrt{- 1} ( {φ}_{{FBG}_{x + 1}} - {φ}_{{FBG}_{x}} )} ) \qquad [ 1.10 ]$$

In equation 1.10, the term

$${e}^{\sqrt{- 1} ( {φ}_{{FBG}_{x}} )}$$

represents the optical phase just before the first FBG in a zone between FBGx and FBGₓ₊₁. This is the common phase and, as can be seen, it changes at optical frequencies far too fast for an optical receiver to discriminate; thus, this term appears to the system as a constant optical power. The intrusion signal is given by the term

$${e}^{\sqrt{- 1} ( {φ}_{{FBG}_{x + 1 }} - {φ}_{{FBG}_{x}} )} ,$$

and in particular to the exponential term containing the phase difference ϕ_{FBG}_{ₓ₊₁}−ϕ_{FBG}_{ₓ}. The sectional interferometric signal for any pair of FBGs is thus independent of the strain/phase variations at any point in the fiber leading up to that pair. All of the zones (e.g., pairs of FBGs) are independent from one another.

In various examples, the system 500 may be configured to process the reflected pulses and detect distortion events in real-time. In the disclosed context, real-time may refer to processing on a time scale such that human operators can be alerted to a distortion event essentially as it occurs, without significant delay, e.g., milliseconds, or other time scales of about 1 to 3 seconds, e.g., 0.8 s, 1 s, 2 s, or 3.1 s.

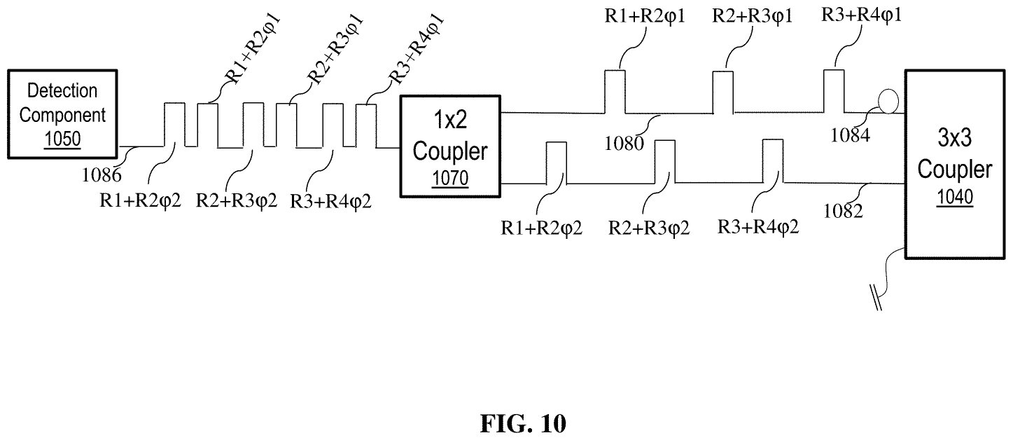

FIG. 10 illustrates an example of a component of a system that uses time domain multiplexing to combine the outputs of a 3×3 coupler. The system may be similar to the system 500 described above. However, two of the outputs of a 3×3 coupler 1040 may be coupled to two optical paths 1080 and 1082 on one end of the respective optical paths. The optical paths 1080 and 1082 may each be a respective length of optical fiber. The other end of the respective optical paths may be coupled to the inputs of a second 1×2 coupler 1070. One of the two optical paths, e.g., optical path 1080, may include a delay element 1084. The delay element 1084 may increase the optical path length of optical path 1080 relative to the length of optical path 1082. The delay element 1084 may be, for example, an additional amount of optical fiber equivalent to about one half of the length separating the FBGs, for example, 0.45×, 0.47×, 0.51×, or 0.53×, or any length that staggers the output of the signals from the two outputs of the 3×3 coupler 1040 without causing the signal on one of the optical paths 1080, 1082 from overlapping the signal on the other optical path. The delay element 1084 causes the arrival of the signals on each of the optical paths at the coupler 1070 to be staggered with respect to each other, so that they can be output on the same output line without interference, effectively multiplexing the signals in the time domain.

The signals received from the optical paths 1080 and 1082 may be combined in the second coupler 1070 and output to another optical path 1086, which may be another optical fiber. The time-domain multiplexed signal may thus include a pulse that is the combination of reflected pulses from two adjacent FBGs, e.g., R1+R2φ1, from one of the outputs of coupler 1040, followed by a pulse that is combination of the same two adjacent FBGs from the other of the outputs of the coupled 1040, e.g., R1+R2φ2. A subsequent pulse may be the combination of reflected pulses from the next pair of adjacent FBGs, e.g., R2+R3, and so forth. In some examples, the spacing of a pair of related pulses, e.g., the two pulses (R1+R2) may be closer together than the spacing of a pulse to the next, unrelated pulse. (Figure not shown to scale.) That is, the temporal separation between pulse R1+R2φ1 and pulse R1+R2φ2 may be smaller than the temporal separation between pulse R1+R2φ1 and pulse R2+R3φ2. For example, the temporal separation between pulse R1+R2φ1 and pulse R1+R2φ2 may be equivalent to the temporal delay introduced by delay element 1084, while the temporal separation between pulse R1+R2φ1 and pulse R2+R3φ2 may be equivalent to about the temporal delay introduced by the spacing “x” between FBGS, or ½*(the length of delay element 522), minus the temporal delay introduced by delay element 1084, or about 1.5×.

The signal output from the coupler 1070 may be provided to a single detection component 1050, which can demultiplex the signal and use the pulse pairs in the signal, e.g., R1+R2φ1 and pulse R1+R2φ2, to generate two sampled time-domain signals. The two signals can be used, as with equation 1.9 above, to generate a phasor signal corresponding to the section of fiber between the FBGs associated with the pulses. Note that the initial unpaired reflection R1 may precede the pairs of pulses (not shown). Following receipt of the unpaired reflected pulse, the detection component 1050 may track, number, count, or group the subsequent pairs of received pulses to associate the pairs with one segment of the optical fiber. For example, pulses R1+R2φ1 and R1+R2φ2 each correspond to the first segment or zone between FBG1 and FBG2.

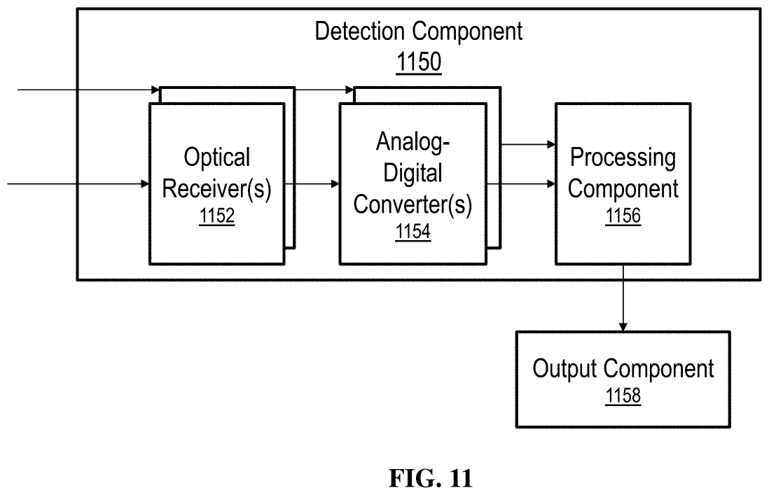

FIG. 11 illustrates a block diagram of an example of a detection component 1150. The detection component 1150 may be a representation of the detection component 550 or 1150. The detection component 1150 may include one or more physical and/or functional components. For example, the detection component 1150 may include one or more optical receivers 1152. An optical receiver may receive a light signal and may measure or detect the power of the received signal. The optical receiver(s) 1152 may also output an electrical signal corresponding to the detected power of the received signal over time.

The detection component 1150 may include two separate optical receivers 1152. One of the two optical receivers may receive a light signal from one of the outputs of the 3×3 coupler 530, while the other of the two optical receivers may receive light from the other of the two used outputs of the 3×2 coupler 530. Alternatively, the detection component 1150 may include one optical receiver, which may receive the time-domain multiplexed signal from the 1×2 coupler 1070. The use of two optical receivers may result in less optical loss compared to use of a single optical receiver, in some embodiments.

The optical receiver(s) 1152 may emit the converted electrical signal to one or more respective analog to digital converter(s) 1154. The analog to digital converter 1154 may be separate from the optical receiver or may be a component within the optical receiver.

The digitized signal may be input to a processing component 1156. The processing component 1156 may include, for example and without limitation, one or more digital signal processors, one or more general-purpose processors, combinations thereof, or any other processing unit(s) capable of and configured to receive the output of the optical receiver in digital form, and to measure a phase difference and detect the presence and location of a distortion event based on a measured phase difference. The processing component 1156 may be a component of the detection component with the optical receiver, as shown, or may be a separately housed device that is communicatively coupled with the optical receiver(s). The processing component 1156 may, for example, be a desktop, laptop, or tablet computer in wired or wireless communication with the optical receiver, or may be a remote computer such as a cloud-based computer or mainframe configured to receive the output of the optical receiver(s).

The processing component 1156 may be configured to process the digitized signal to measure a phase difference between two signals where one of the two signals is reflected from one FBG and the other of the two signals is reflected from an adjacent FBG. The processing component 1156 may execute software and/or hardware instructions to perform calculations, such as, for example, calculations to solve equation 1.9. The processing component 1156 may use a measured phase difference to generate a spectrograph, as described above, to detect a distortion event between a pair of adjacent FBGs. When a distortion event is detected, the processing component 1156 may emit an alert. The alert may include information about the detected distortion event, such as the specific location where the event was detected, a time of detection, signal strength, or other information as may be specified.

The processing component 1156 may communicate with an output component 1158. The output component 1158 may be, for example, a visual display, an audio speaker, or other means of presenting information to a human operator. The output component 1158 may additionally, or alternatively, produce machine-readable output which may be, for example, provided to additional processes, or stored. The output component 1158 may receive the alert from the processing component 1156 and present the information in the alert, e.g., via a message or other visual indicator on a screen, via an audible alarm, or a combination thereof. In some examples, the output component 1158 may be configured to initiate a telephone call and/or send messages such as electronic mail messages, short message service (SMS) messages, push notifications, or the like to remote devices to alert one or more human operators.

It was noted above that equation 1.8, which calculates a change in the time-sampled phasor's phase, assumes that the phasor moves less than 180 degrees. This assumption is related to the Nyquist sampling theorem, which stipulates that a sampling rate for any continuous, periodic, bandwidth-limited function must be at least twice as high as the highest frequency in the bandwidth-limited function in order to be able to decompose the function into the summation of a finite set of orthogonal sinusoidal functions. If the Nyquist conditions are not met, then a phenomenon called aliasing can occur. For example, suppose a waveform is sampled at 1280 Hz, then the highest signal frequency without aliasing is 640 Hz. If the sampling system encounters a frequency at 700 Hz, it will appear in the discrete transform at 640−(700−640)=580 Hz.

When sampling a rotating phasor, the same sampling constraints of the Nyquist sampling theorem apply as for any other sampling problem. For a rotating phasor, the highest frequency is determined by the shortest time required for the phasor to rotate through 2π radians; so, it follows from the Nyquist sampling theorem that the system must sample the phasor faster than the time required for it to move through π (180°).

Quadrature measurements are based on quantifying the phase of the phasor, and the acquisition system must sample the phasor consistent with the Nyquist sampling theorem for this to happen. It's important to remember, however, that the phasor's frequency (rate of rotation) may be very different from the frequency of the phenomenon that causes the phase disturbance. For example, if a small acoustic speaker is attached to the sensing fiber, and tuned to 300 Hz, the resulting phase is likely to change by less than 2π, so that the phasor rotates at 300 Hz. But suppose the sensing fiber is attached to a large industrial generator operating 60 Hz, where the amplitude of vibration moves through 50π radians per cycle. In this case, the phasor will move at

$$60 \cdot ( \frac{50 π}{2 π} ) = 1 \text{,} 500 Hz .$$

If, as in the earlier example, the system samples at 1280 Hz, aliasing will occur. The problem of aliasing in the interferometer is a function of both the amplitude of the strain that arises from the disturbance and the frequency of the disturbance.

In an embodiment, the system 500 may sample the phasor at a rate of about 0.1 sec/128, or about 0.78 ms of phasor data, which may include about 10-100 pulses. Different sample rates may be selected in part according to, for example, the frequency of phenomenon to be detected. In a security application, for example, metal fences vibrate at a relatively low frequency, so a higher sampling rate may not be necessary.

### Measuring Temperature and Changes in Temperature

In addition to sensing distortion events caused by some physical deformation of the optical fiber such as pressure and/or vibrations applied near the optical fiber, the systems described herein can also sense changes in temperature at particular segments of the optical fiber. Changes in temperature may cause changes in strain of the optical fiber. This capability may be used, for example, when the optical fiber is installed near a pipeline, to detect temperature changes due to a leaked fluid in the vicinity.

Accordingly, the systems described herein may be used to detect changes in temperature and measure actual temperature. In order to be useful as a temperature change detector, optical fiber is advantageously installed in an area that does not change temperature rapidly under normal operating conditions, e.g., where any normal thermal variation may take place over hours rather than minutes, such as underground. The optical fiber is also advantageously installed in an area that experiences little strain variation, such as acoustic vibrations, under normal operating conditions.

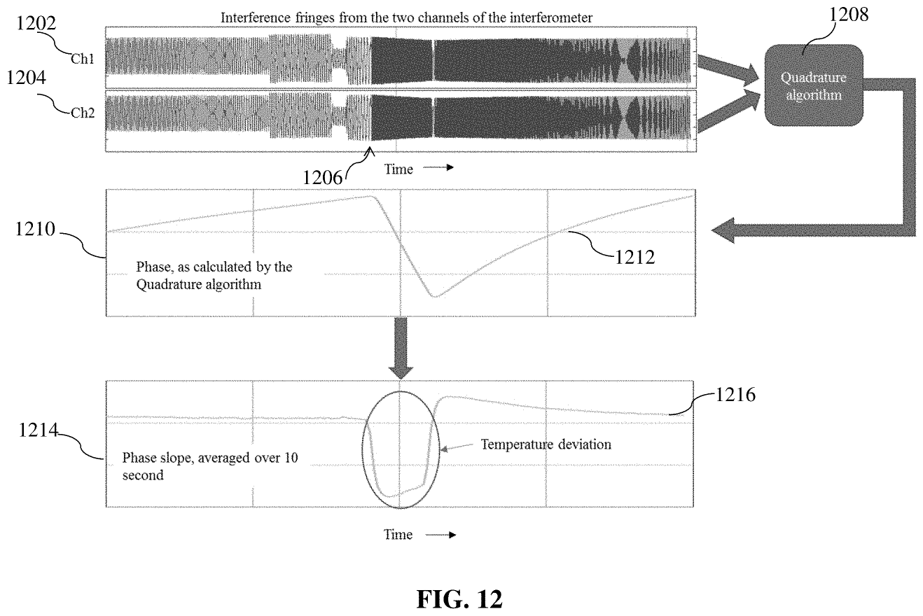

FIG. 12 illustrates aspects of measuring a change in temperature using the interferometer systems described herein. The data shown reflect a field test using a 40-meter-long optical fiber having FBGs, coiled in a warehouse environment where a heat lamp is introduced after nine minutes, for a duration of two minutes, to raise the temperature of one part of the optical fiber. Plot 1202 represents interference fringes, i.e., the optical power, received over time from one output or channel of the 3×3 coupler, e.g., from optical path 526. Plot 1204 represents interference fringes received over time from another output or channel of the 3×3 coupler, e.g., from optical path 528. The plots show the change in the fringes that occurred at time 1206, where a heat source was introduced near the optical fiber of an exemplary system such as the system 500.

For each channel, the derivative of the strain-induced phase is calculated using the quadrature algorithm 1208. The time-domain derivative of the strain-induced phase is the phase of the phasor at a time t, minus the phase of the phasor at a time t−δt. Since the quadrature measurement calculates the angle of the phasor at each sample point, this derivative calculation is the difference between the phasor angles at adjacent sample points. The waveform resulting from calculating the derivative, the result of equation 1.8, is a vibrational signature that can be used to detect other distortion events as discussed above. Then, to get the total phase, the quadrature algorithm may integrate or sum over the waveform, as in equation 1.9. The total phase derived from the interference fringes in plots 1202 and 1204 is illustrated as line 1212 in plot 1210.

To identify a change in the temperature, a mean slope of the phase is calculated over a particular time interval, e.g., 1 second. Plot 1214 represents the slope of the line 1212, averaged over 10 seconds, in this example, represented by line 1216. Of note is that the slope changes abruptly at time 1206, when the heat source is introduced.

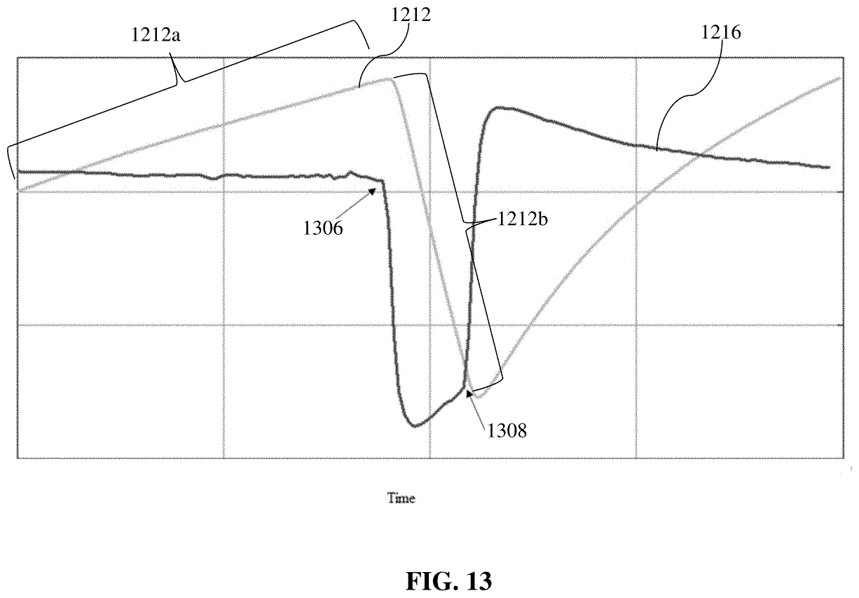

FIG. 13 illustrates the phase line 1212 and the averaged slope line 1216 from FIG. 12 together on one plot over time. Point 1306 identifies where the heat source was turned on or introduced at a portion of the optical fiber, and point 1308 represents where the heat source was turned off or removed.

Of note in FIG. 13 is that the absolute phase line 1212, related to the strain, begins, in section 1212a, with a slight upward slope. The strain may be due to the optical fiber cooling or otherwise adjusting to the background temperature of its environment. An optical fiber at a stable temperature will show little to no change in strain and thus the slope of the absolute phase line would be essentially zero, e.g., less than 10.11, or less than 10.011. When the heat source was turned on, the slope changed sign and increased, as seen in section 1212b. The initial slope prior to the introduction of the heat source was due to changing strain in the entire length of fiber associated with that section, whereas the heat lamp only heated a portion of optical fiber roughly ½ meter long.

In one example, the slope in section 1212a was about 0.33, the slope in section 1212b was about 1.25, and the increase in temperature from the heat lamp was about 7 Kelvin (measured independently). From these data, the change in background environmental temperature in this example can be estimated to be about 11 thousandths of a Kelvin per minute:

$$\frac{0.5 \cdot m \cdot 7 \cdot K}{2 \cdot min} = 1.25 \cdot cal\_constant$$

$$calibration\_constant = 1.4$$

$$\frac{40 \cdot m \cdot Δ {T}_{e n v}}{9 \cdot min} = 0.33 \cdot cal\_constant = 0.33 \cdot 1.4 = 0.462$$

$$Δ {T}_{e n v} = 0.1 \cdot K in 9 minutes$$

$$Rate of change = 0.011 Kelvin per minute$$

Thus, the system 500 may identify a change in temperature in the optical fiber from the mean slope of the phase calculated over a particular time interval, which may be useful, for example, to detect a fluid leaking from a pipeline. Of note is that changes in temperature are generally slower than intrusions. Accordingly, a distortion event caused by a temperature change may be distinguished from a distortion event caused by an intrusion by the differences in the related spectrographic data for the two types of events.

The system 500 may be used to measure a temperature change in another way that does not rely on the quadrature approach, by using relationships among fringe visibility, optical path length differences, and temperature, as will be described below. This method may be less precise than the approach described above, but may still provide an indication of a temperature change. There is a need to measure changes in temperatures at longer distances with passive optical fiber in several industries. For example, operators of oil and gas pipelines can use detected changes in temperature to locate leaks, as discussed above. Utility companies can use distributed temperature sensors to detect an excess in current leading to wasted energy. Distributed temperature sensors may be used, for example, to detect fires in remote locations, for example, in tunnels.

In the system 500, when the delay element 522 is held in a temperature-controlled environment, a difference in temperature between the delay element and a segment of the optical fiber may cause differential thermal expansion in the optical fiber. Such a temperature differential may change the fringe visibility and allow the temperature to be calculated at the FBG section. For example, when the FBG optical fiber is at a different temperature than the delay element, and expands more/less than the delay element, the fringe visibility changes due to a change in the difference of the optical path lengths of a pair of interfering pulses.

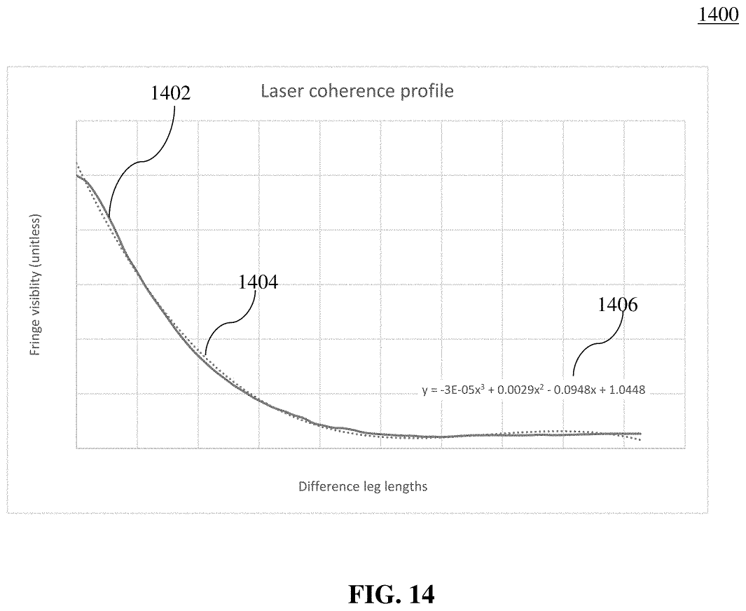

FIG. 14 shows a graph 1400 that illustrates an example of a relationship between optical path length differences and fringe visibility. The graph 1400 reflects the change in fringe visibility (y-axis) as the difference in optical path length between two optical paths, or “legs”, of an interferometer increases, in 1 mm increments (x-axis). For example, in the system 500, increasing the spacing between a pair of FBGs while keeping the delay caused by the delay element constant, effectively changes the path length of one “leg” of the interferometer. The measured fringe visibility is shown as solid line 1402. This relationship can be fit to a 3^{rd} or higher degree polynomial 1406, shown as dashed line 1404. Accordingly, if one knows the fringe visibility, the difference in optical path lengths can be determined using the 3^{rd} degree polynomial fit to the relationship between optical path lengths and fringe visibility for a given laser profile.

In an optical fiber such as may be used in the system 500, the thermal expansion coefficient for the silicone glass in the fiber can be used to determine how much the optical fiber expands for each degree of warming. In one example, a thermal expansion coefficient of silicone glass may be approximately α=4×10⁻⁷C⁻¹, giving the expansion in the optical fiber for one degree of temperature change on a 20-meter segment as: 2×20 m×α×1 C=1.6 mm. Thus, every degree of change in temperature with respect to a reference temperature results in an increase of 1.6 mm in the optical fiber of the example. Different thermal expansion coefficients for other optical fiber may give rise to a different relationship between expansion and temperature.

Knowing the relationship between fringe visibility and optical path difference, and the relationship between optical path difference and temperature change, the relationship between fringe visibility and temperature change can be determined.

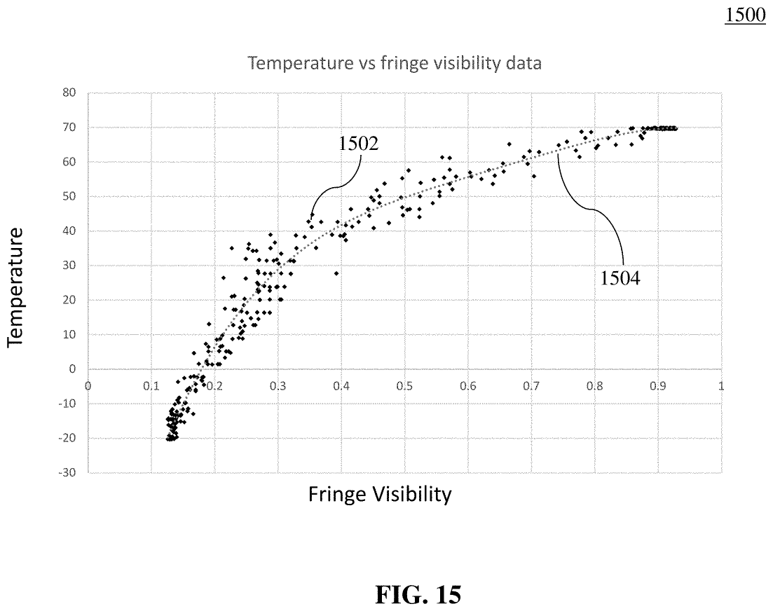

FIG. 15 shows a graph 1500 that illustrates one example of a relationship between fringe visibility and temperature. The graph 1500 represents a particular example of test data measured at 5-minute intervals over a 24-hour period, where temperature was cycled between −20 C and 70 C about every 3 hours. The x-axis represents fringe visibility, calculated by: FV=(Max−Min)/(Max+Min) where Max represents the maximum observed power and Min represents the minimum observed power. The y-axis represents the temperature. The individually measured data points, e.g., point 1502, are fit to a 4^{th} order polynomial with R²=0.979, indicated by dotted line 1504. Thus, with a measured fringe visibility for a given section of an FBG fiber optic cable, the temperature of that section can be measured. The data shown represent one example for a particular fiber optic cable. A different relationship between fringe visibility and temperature may exist for different cables, or for lasers with different coherence lengths, e.g., when the thermal expansion coefficient of the optical fiber in the fiber optic cable is different, or in a different range of temperatures.

### III. Other Exemplary Embodiments

The examples described above generally concern various principles related to interferometer-based sensor devices, and related systems and methods. The previous description is provided to enable a person skilled in the art to make or use the disclosed principles. Embodiments other than those described above in detail are contemplated based on the principles disclosed herein, together with any attendant changes in configurations of the respective apparatus or changes in order of method acts described herein, without departing from the spirit or scope of this disclosure. Various modifications to the examples described herein will be readily apparent to those skilled in the art.

For example, other types and/or configurations of optical paths may be used. Fiber optic cables having optical fiber without FBGs may be used in combination with other reflective devices such as mirrors.

### IV. Computing Environments

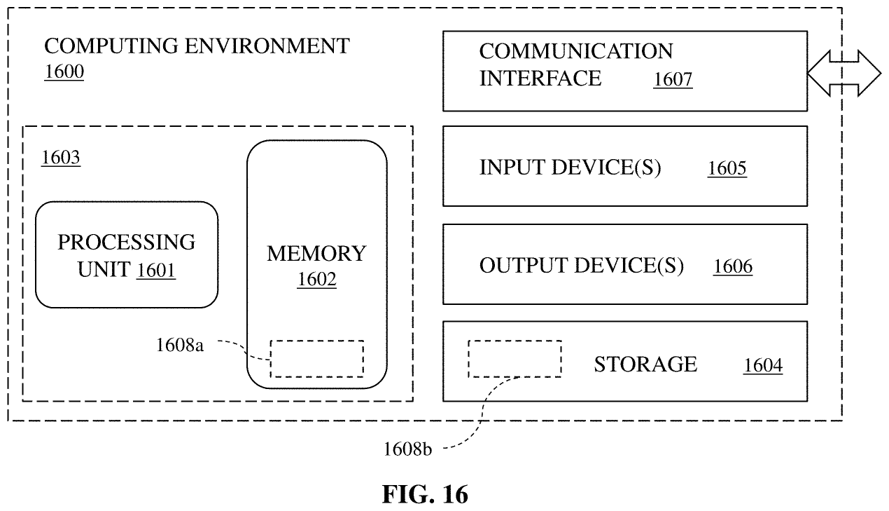

FIG. 16 illustrates a generalized example of a suitable computing environment 1600 in which described methods, embodiments, techniques, and technologies relating, for example, to detecting and measuring a distortion event on an FBG sensor system can be implemented. The computing environment 1600 is not intended to suggest any limitation as to scope of use or functionality of the technologies disclosed herein, as each technology may be implemented in diverse general-purpose or special-purpose computing environments. For example, each disclosed technology may be implemented with other computer system configurations, including wearable and/or handheld appliances, multiprocessor systems, microprocessor-based or programmable consumer electronics, embedded platforms, network computers, minicomputers, mainframe computers, smartphones, tablet computers, data centers, and the like. Each disclosed technology may also be practiced in distributed computing environments where tasks are performed by remote processing devices that are linked through a communications connection or network. In a distributed computing environment, program modules may be located in both local and remote memory storage devices.

The computing environment 1600 includes at least one central processing unit 1601 and a memory 1602. In FIG. 16, this most basic configuration 1603 is included within a dashed line. The central processing unit 1601 executes computer-executable instructions and may be a real or a virtual processor. In a multi-processing system, or in a multi-core central processing unit, multiple processing units execute computer-executable instructions (e.g., threads) to increase processing speed and as such, multiple processors can run simultaneously, despite the processing unit 1601 being represented by a single functional block.

A processing unit, or processor, can include an application specific integrated circuit (ASIC), a general-purpose microprocessor, a field-programmable gate array (FPGA), a digital signal controller, or a set of hardware logic structures (e.g., filters, arithmetic logic units, and dedicated state machines) arranged to process instructions.

The memory 1602 may be volatile memory (e.g., registers, cache, RAM), non-volatile memory (e.g., ROM, EEPROM, flash memory, etc.), or some combination of the two. The memory 1602 stores instructions for software 1608a that can, for example, implement one or more of the technologies described herein, when executed by a processor. Disclosed technologies can be embodied in software, firmware or hardware (e.g., an ASIC).

A computing environment may have additional features. For example, the computing environment 1600 includes storage 1604, one or more input devices 1605, one or more output devices 1606, and a communication interface 1607. An interconnection mechanism (not shown) such as a bus, a controller, or a network, can interconnect the components of the computing environment 1600. Typically, operating system software (not shown) provides an operating environment for other software executing in the computing environment 1600, and coordinates activities of the components of the computing environment 1600.

The storage 1604 may be removable or non-removable, and can include selected forms of machine-readable media. In general, machine-readable media includes magnetic disks, magnetic tapes or cassettes, non-volatile solid-state memory, CD-ROMs, CD-RWs, DVDs, magnetic tape, optical data storage devices, and carrier waves, or any other machine-readable medium which can be used to store information, and which can be accessed within the computing environment 1600. The storage 1604 can store instructions for the software 1608b that can, for example, implement technologies described herein, when executed by a processor.

The storage 1604 can also be distributed, e.g., over a network so that software instructions are stored and executed in a distributed fashion. In other embodiments, e.g., in which the store 1604, or a portion thereof, is embodied as an arrangement of hardwired logic structures, some (or all) of these operations can be performed by specific hardware components that contain the hardwired logic structures. The storage 1604 can further be distributed, as between or among machine-readable media and selected arrangements of hardwired logic structures. Processing operations disclosed herein can be performed by any combination of programmed data processing components and hardwired circuit, or logic, components.

The input device(s) 1605 may be any one or more of the following: a touch input device, such as a keyboard, keypad, mouse, pen, touchscreen, touch pad, or trackball; a voice input device, such as one or more microphone transducers, speech-recognition technologies and processors, and combinations thereof; a scanning device; or another device, that provides input to the computing environment 1600.

The output device(s) 1606 may be any one or more of a display, printer, loudspeaker transducer, DVD-writer, signal transmitter, or another device that provides output from the computing environment 1600. An output device can include or be embodied as a communication interface 1607.

The communication interface 1607 enables communication over or through a communication medium (e.g., a connecting network) to another computing entity. A communication interface can include a transmitter and a receiver suitable for communicating over a local area network (LAN), a wide area network (WAN) connection, or both. LAN and WAN connections can be facilitated by a wired connection or a wireless connection. If a LAN or a WAN connection is wireless, the communication interface can include one or more antennas or antenna arrays. The communication medium conveys information such as computer-executable instructions, compressed graphics information, processed signal information (including processed audio signals), or other data in a modulated data signal. Examples of communication media for so-called wired connections include fiber-optic cables and copper wires. Communication media for wireless communications can include electromagnetic radiation within one or more selected frequency bands.

Machine-readable media are any available media that can be accessed within a computing environment 1600. By way of example, and not limitation, with the computing environment 1600, machine-readable media include memory 1602, storage 1604, communication media (not shown), and combinations of any of the above. Tangible machine-readable (or computer-readable) media exclude transitory signals.

As explained above, some disclosed principles can be embodied in a store 1604. Such a store can include tangible, non-transitory machine-readable medium (such as microelectronic memory) having stored thereon or therein instructions. The instructions can program one or more data processing components (generically referred to here as a “processor”) to perform one or more processing operations described herein, including estimating, computing, calculating, measuring, adjusting, sensing, measuring, filtering, correlating, and decision making, as well as, by way of example, addition, subtraction, inversion, and comparison. In some embodiments, some or all of these operations (of a machine process) can be performed by specific electronic hardware components that contain hardwired logic (e.g., dedicated digital filter blocks). Those operations can alternatively be performed by any combination of programmed data processing components and fixed, or hardwired, circuit components.

Directions and other relative references (e.g., up, down, top, bottom, left, right, rearward, forward, etc.) may be used to facilitate discussion of the drawings and principles herein, but are not intended to be limiting. For example, certain terms may be used such as “up,” “down,”, “upper,” “lower,” “horizontal,” “vertical,” “left,” “right,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” surface can become a “lower” surface simply by turning the object over. Nevertheless, it is still the same surface and the object remains the same. As used herein, “and/or” means “and” or “or”, as well as “and” and “or.” Moreover, all patent and non-patent literature cited herein is hereby incorporated by reference in its entirety for all purposes.

And, those of ordinary skill in the art will appreciate that the exemplary embodiments disclosed herein can be adapted to various configurations and/or uses without departing from the disclosed principles. Applying the principles disclosed herein, it is possible to provide a wide variety of interferometer-based sensor devices, and related methods and systems. For example, the principles described above in connection with any particular example can be combined with the principles described in connection with another example described herein. Thus, all structural and functional equivalents to the features and method acts of the various embodiments described throughout the disclosure that are known or later come to be known to those of ordinary skill in the art are intended to be encompassed by the principles described and the features and acts claimed herein. Accordingly, neither the claims nor this detailed description shall be construed in a limiting sense, and following a review of this disclosure, those of ordinary skill in the art will appreciate the wide variety of interferometer-based sensor devices, and related methods and systems that can be devised under disclosed and claimed concepts.

Moreover, nothing disclosed herein is intended to be dedicated to the public regardless of whether such disclosure is explicitly recited in the claims. To aid the Patent Office and any readers of any patent issued on this application in interpreting the claims appended hereto or otherwise presented throughout prosecution of this or any continuing patent application, applicants wish to note that they do not intend any claimed feature to be construed under or otherwise to invoke the provisions of 35 USC 112(f), unless the phrase “means for” or “step for” is explicitly used in the particular claim.

The appended claims are not intended to be limited to the embodiments shown herein, but are to be accorded the full scope consistent with the language of the claims, wherein reference to a feature in the singular, such as by use of the article “a” or “an” is not intended to mean “one and only one” unless specifically so stated, but rather “one or more”.

Thus, in view of the many possible embodiments to which the disclosed principles can be applied, we reserve the right to claim any and all combinations of features and acts described herein, including the right to claim all that comes within the scope and spirit of the foregoing description, as well as the combinations recited, literally and equivalently, in any claims presented anytime throughout prosecution of this application or any application claiming benefit of or priority from this application, and more particularly but not exclusively in the claims appended hereto.

We currently claim:

1. An apparatus, comprising:
a fiber optic cable comprising an optical fiber having a plurality of regions with a gradient in refractive index distributed longitudinally throughout a segment of the optical fiber;
a light source configured to emit a pulse of coherent light into the optical fiber;
a first coupler optically coupled to the fiber optic cable and so configured to receive a corresponding pulse of light reflected from each respective region and to split each respective received pulse into a corresponding upper output and a corresponding lower output;
a first optical path optically coupled to the upper output and comprising a delay element;
a second optical path optically coupled to the lower output and having a length shorter than the first optical path;
a second coupler having a first input coupled to the first optical path, and a second input coupled to the second optical path, and configured to receive and combine a first received pulse from the first optical path with a second received pulse from the second optical path into a combined pulse, and to output the combined pulse to each of a first output and a second output, wherein the first output and the second output are out of phase with each other; and
a detection component configured to receive the combined pulse from the respective first output and from the respective second output, and to detect a distortion event at a location between a pair of adjacent regions based on a phase difference between the first received pulse and the second received pulse of the combined pulse.

2. The apparatus of claim 1, wherein the detection component comprises:
a first optical receiver coupled to the first output and configured to convert the received combined pulse to a first electronic signal;
a second optical receiver coupled to the second output and configured to convert the received combined pulse to a second electronic signal; and
a processing component configured to receive the first and second electronic signals, to measure a phase difference between the first received pulse and the second received pulse based on the first and second electronic signals, and to detect the distortion event at a location between a pair of adjacent regions based on the measured phase difference.

3. The apparatus of claim 1, wherein the first output of the second coupler and the second output of the second coupler are out of phase with each other by about 120 degrees.

4. The apparatus of claim 1, wherein each respective region is spaced apart from an adjacent region by a first distance, and wherein the delay element has a length that is about an integral multiple of the first distance.

5. The apparatus of claim 1, further comprising: a circulator configured to direct a light pulse from the light source to the optical fiber, and a reflected pulse of light from the optical fiber to the first coupler.

6. The apparatus of claim 1, further comprising: a phase modulator coupled to the second optical path configured to normalize the signal.

7. The apparatus of claim 1, further comprising: a polarization controller configured to receive a series of pulses of light from the light source and to vary the polarization of the pulses of light.

8. The apparatus of claim 1, wherein the detection component comprises:
a third optical path coupled to the first output of the second coupler and having a second delay element;
a fourth optical path coupled to the second output of the second coupler;
a third coupler having a right input coupled to the third optical path and a left input coupled to the fourth optical path, the third coupler configured to multiplex the optical signals received at the right and left inputs in the time-domain and output the multiplexed signal;
an optical receiver coupled to the third coupler and configured to receive and convert the time-domain multiplexed signal convert the received recombined pulse to an electronic signal; and
a processing component configured to receive the first and second electronic signals, to measure the phase difference between the first received pulse and the second received pulse based on the first and second electronic signals, and to detect the distortion event at a location between a pair of adjacent regions based on the measured phase difference.

9. The apparatus of claim 8, wherein each respective region is spaced apart from an adjacent FBG by a first distance and wherein the second delay element has a length less than the first distance.

10. The apparatus of claim 9, wherein the second delay element has a length that is one half of the first distance.

11. The apparatus of claim 1, wherein the detection component is further configured to emit an alert when a distortion event is detected.

12. The apparatus of claim 1, wherein the detection component is further configured to detect the distortion event in real-time.

13. The apparatus of claim 1, wherein the plurality of regions with a gradient in refractive index comprise a plurality of fiber Bragg gratings.

14. A sensor, comprising:
a first coupler having an optical coupling configured to receive a series of pulses of light and so configured to split each respective received pulse into a corresponding upper output and a corresponding lower output;
a first optical path optically coupled to the upper output and comprising a delay element;
a second optical path coupled to the lower output having a length shorter than the first optical path;
a second coupler having a first input coupled to the first optical path, and a second input coupled to the second optical path, and configured to receive and combine a first received pulse from the first optical path with a second received pulse from the second optical path into a combined pulse, and to output the combined pulse to each of a first output and a second output, wherein the first output and the second output are out of phase with each other; and
a detection component configured to receive the combined pulse from the respective first output and from the respective second output, and to detect a distortion event based on a phase difference between the first received pulse and the second received pulse of the combined pulse.

15. The sensor of claim 1429, further comprising:
a fiber optic cable, connected to the coupling, comprising an optical fiber having a plurality of fiber Bragg gratings (FBG) spaced apart from each other; and
a light source configured to emit a pulse of coherent light into the optical fiber.

16. The sensor of claim 15, wherein each respective FBG is spaced apart from an adjacent FBG by a first distance, and wherein the delay element has a length that is about an integral multiple of the first distance.

17. The sensor of claim 1524, wherein the first received pulse corresponds to a pulse reflected from a first FBG and the second received pulse corresponds to a pulse reflected from an FBG serially adjacent to the first FBG.

18. The sensor of claim 1429, wherein the length of the second optical path is one half of a length of the first optical path.

19. The sensor of claim 14, wherein the first output of the second coupler and the second output of the second coupler are out of phase with each other by about 120 degrees.

20. A system comprising:
a fiber optic cable comprising an optical fiber having a plurality of fiber Bragg gratings (FBG) spaced apart from each other;
a light source configured to emit a pulse of coherent light into the optical fiber; and
an interferometric sensor apparatus configured to receive a corresponding pulse of light reflected from each respective FBG, identify a segment of the optical fiber between a pair of adjacent FBGs experiencing strain, the identifying based on the received pulses of reflected light, and output an alert responsive to identifying the segment experiencing strain.
